(19) United States
(12) Patent Application Publication
(10) Pub. No.: US 2025/0190646 A1
(43) Pub. Date: Jun. 12, 2025

(54) VIRTUAL METROLOGY METHOD BASED ON A LONG SEQUENCE TIME-SERIES PREDICTION FRAMEWORK AND SYSTEM THEREOF

(71) Applicant: NATIONAL CHENG KUNG UNIVERSITY, Tainan City (TW)

(72) Inventors: Hao TIENG, Tainan City (TW); Haw-Ching YANG, Tainan City (TW); Fan-Tien CHENG, Tainan City (TW)

(21) Appl. No.: 18/805,548

(22) Filed: Aug. 15, 2024

(30) Foreign Application Priority Data
Dec. 8, 2023 (TW) 112147853

(51) Int. Cl. G06F 30/18; G05B 19/4155

(52) U.S. Cl. CPC G06F 30/18; G05B 19/4155; G05B 2219/2639

(57) ABSTRACT

Right decisions can only be made via understanding future trends. For example, energy consumption prediction is the basis of all Energy Management Systems (EMS). Any EMS decision-making must rely on the energy consumption prediction value for subsequent power grid planning or factory management. These prediction values play decisive roles in planning and management. A virtual metrology method based on a long sequence time-series prediction framework develops the Automatic Virtual Metrology (AVM) which can provide accurate predictive future trends to increase decision-making accuracy (such as production scheduling or facility control). The built-in period calculator module is used to automatically find out a best memorizing length, a best forecasting length and a best full-periodic pattern length for the long sequence time-series prediction framework. The procedure of advanced dual-phase algorithm is enhanced to achieve self-updating with time for the AVM based on the long sequence time-series prediction framework.

### RELATED APPLICATIONS

This application claims priority to Taiwan Application Serial Number 112147853, filed Dec. 8, 2023, which is herein incorporated by reference.

### BACKGROUND

### Technical Field

The present disclosure relates to a virtual metrology method and a system thereof. More particularly, the present disclosure relates to a virtual metrology method based on a long sequence time-series prediction framework and a system thereof.

### Description of Related Art

Automatic virtual metrology (AVM) can collect the data from the process tools to conjecture the virtual metrology values in the prediction model for realizing the goal of online and real-time total inspection. A first conventional AVM using a back propagation neural network (BPNN) and a second conventional AVM using a deep convolutional neural network (CNN) model can obtain the relationship between current process data and current metrology data, and accurately estimate the corresponding quality of the current process, thus successfully realizing zero-defect manufacturing in Industry 4.1 in various industries. However, the first conventional AVM and the second conventional AVM perform poorly when processing data with time series characteristics and predicting the future by past data and future data, and they are unable to perform long sequence time-series prediction for the future. Therefore, a virtual metrology method based on a long sequence time-series prediction framework and a system thereof which are capable of providing accurate predictive future trends are commercially desirable.

### SUMMARY

An object of the present disclosure is to provide a virtual metrology method based on a long sequence time-series prediction framework and a system thereof. The virtual metrology method based on the long sequence time-series prediction framework and the system thereof can predict the future trend of specific data by using the deep learning model and the built-in period calculator. In addition, the present disclosure provide a model updating method (an advanced dual-phase algorithm) suitable for the long sequence time-series prediction framework to be capable of increasing adaptability and feasibility of the AVM on various applications (e.g., factory energy consumption prediction, solar power generation prediction, etc.), thereby solving the problem that the conventional AVM cannot predict future trends.

According to one aspect of the present disclosure, a virtual metrology method based on a long sequence time-series prediction framework includes a plurality of steps. A first one of the steps includes configuring a processor to obtain a plurality of sets of process data and a plurality of metrology data. The sets of process data include past data and future data of a manufacturing device relative to a time point, and the metrology data include a plurality of actual measurement values of a measurement device. A second one of the steps includes performing a period calculation operation. The period calculation operation includes configuring the processor to calculate the sets of process data and the metrology data according to an autocorrelation function and a confidence interval function of the autocorrelation function so as to find out a memorizing length, a forecasting length and a full-periodic pattern length for the long sequence time-series prediction framework. A third one of the steps includes performing a modeling operation. The modeling operation includes configuring the processor to use the memorizing length, the forecasting length and the full-periodic pattern length to establish a virtual metrology model based on the long sequence time-series prediction framework. The virtual metrology model based on the long sequence time-series prediction framework includes at least one deep learning network model. A fourth one of the steps includes performing a calculating operation. The calculating operation includes configuring the processor to obtain at least one of another set of process data and another actual measurement value of the manufacturing device, and executing one of a first step and a second step according to whether the another actual measurement value is obtained, thereby calculating one of a phase-one virtual metrology value and a phase-two virtual metrology value of the manufacturing device. The first step includes calculating the phase-one virtual metrology value by the another set of process data according to the virtual metrology model based on the long sequence time-series prediction framework, and the second step includes calculating the phase-two virtual metrology value of the manufacturing device by the another set of process data and the another actual measurement value according to the virtual metrology model based on the long sequence time-series prediction framework.

Therefore, the virtual metrology method of the present disclosure develops the automatic virtual metrology based on the long sequence time-series prediction framework, which can provide accurate predictive future trends to increase decision-making accuracy. The built-in period calculator is used to automatically find out the best memorizing length, the best forecasting length and the best full-periodic pattern length for the long sequence time-series prediction framework. The procedure of the advanced dual-phase algorithm is also enhanced to achieve self-updating with time for the automatic virtual metrology based on the long sequence time-series prediction framework.

In some embodiments, the manufacturing device includes a production equipment, a factory equipment and a microgrid equipment. The measurement device includes a power meter. The sets of process data include production line information of the production equipment, factory information of the factory equipment, microgrid information of the microgrid equipment and environmental information. Each of the phase-one virtual metrology value generated in the first step and the phase-two virtual metrology value generated in the second step is configured to control the manufacturing device, thereby updating the actual measurement values of the power meter.

In some embodiments, the period calculation operation further includes performing a first period calculating step, a second period calculating step, a third period calculating step, a fourth period calculating step and a fifth period calculating step. The first period calculating step includes defining a searching range, and the searching range is a positive integer greater than 1. The second period calculating step includes setting a lag value to 1. The third period calculating step includes calculating the sets of process data and the metrology data according to the autocorrelation function and the confidence interval function of the autocorrelation function to generate an autocorrelation function value and a confidence interval. The fourth period calculating step includes adding the lag value by 1 to generate an added lag value, and then setting the lag value to the added lag value. The fifth period calculating step includes judging whether the lag value exceeds the searching range to generate a judgment result, and then determining the full-periodic pattern length according to the judgment result.

In some embodiments, the period calculation operation further includes performing a sixth period calculating step, a seventh period calculating step and an eighth period calculating step. The sixth period calculating step includes finding the lag value when the autocorrelation function value falls into the confidence interval at a first time, and setting the memorizing length to the lag value when the autocorrelation function value falls into the confidence interval at the first time, and finding the lag value of a largest one of the autocorrelation function value that exceeds the memorizing length, and setting the full-periodic pattern length to the lag value of the largest one of the autocorrelation function value. The seventh period calculating step includes setting the forecasting length according to the memorizing length. The eighth period calculating step includes outputting the memorizing length, the forecasting length and the full-periodic pattern length. The forecasting length is a multiple of the memorizing length. In response to determining that the judgment result of the fifth period calculating step is yes, the sixth period calculating step is performed, and in response to determining that the judgment result of the fifth period calculating step is no, the third period calculating step is reperformed.

In some embodiments, in the calculating operation, in response to determining that the another actual measurement value is not obtained, performing the first step to calculate the phase-one virtual metrology value of the manufacturing device. In response to determining that the another actual measurement value is obtained, performing the second step to calculate the phase-two virtual metrology value of the manufacturing device.

In some embodiments, the first step includes converting another set of process data of the manufacturing device into a set of format length process data according to the memorizing length and the forecasting length, and then inputting the set of format length process data of the manufacturing device into the virtual metrology model based on the long sequence time-series prediction framework, thereby calculating the phase-one virtual metrology value of the manufacturing device.

In some embodiments, the second step includes performing a strategy selection confirming step on the another actual measurement value of the manufacturing device to generate a confirmation result, and performing one of a first strategy step and a second strategy step according to the confirmation result to update the virtual metrology model based on the long sequence time-series prediction framework; and inputting the another set of process data of the manufacturing device into the virtual metrology model based on the long virtual metrology value of the manufacturing device.

In some embodiments, the strategy selection confirming step includes confirming whether the manufacturing device performs a manual activation operation. In response to determining that the confirmation result is no, the second step further includes confirming whether the virtual metrology model based on the long sequence time-series prediction framework needs to be refreshed to generate a refreshing confirmation result, and determining whether to perform the first strategy step according to the refreshing confirmation result. In response to determining that the confirmation result is yes, the second step performs the second strategy step. The manual activation operation includes that the manufacturing device is expected to change significantly.

In some embodiments, in the second step, the first strategy step includes updating the virtual metrology model based on the long sequence time-series prediction framework according to the memorizing length and the forecasting length; and the second strategy step includes reperforming the period calculation operation to find another memorizing length, another forecasting length and another full-periodic pattern length, and then updating the virtual metrology model based on the long sequence time-series prediction framework according to the another memorizing length, the another forecasting length and the another full-periodic pattern length.

According to another aspect of the present disclosure, a virtual metrology system based on a long sequence time-series prediction framework includes a memory and a processor. The memory is configured to store a plurality of sets of process data and a plurality of metrology data. The sets of process data include past data and future data of a manufacturing device relative to a time point, and the metrology data include a plurality of actual measurement values of a measurement device. The processor is electrically connected to the memory. The processor receives the sets of process data and the actual measurement values, and is configured to perform a period calculation operation, a modeling operation and a calculating operation. The period calculation operation includes calculating the sets of process data and the metrology data according to an autocorrelation function and a confidence interval function of the autocorrelation function so as to find out a memorizing length, a forecasting length and a full-periodic pattern length for the long sequence time-series prediction framework. The modeling operation includes using the memorizing length, the forecasting length and the full-periodic pattern length to establish a virtual metrology model based on the long sequence time-series prediction framework. The virtual metrology model based on the long sequence time-series prediction framework includes at least one deep learning network model. The calculating operation includes obtaining at least one of another set of process data and another actual measurement value of the manufacturing device, and executing one of a first step and a second step according to whether the another actual measurement value is obtained, thereby calculating one of a phase-one virtual metrology value and a phase-two virtual metrology value of the manufacturing device. The first step includes calculating the phase-one virtual metrology value by the another set of process data according to the virtual metrology model based on the long sequence time-series prediction framework, and the second step includes calculating the phase-two virtual metrology value of the manufacturing device by the another set of process data and the another actual measurement value according to the virtual metrology model based on the long sequence time-series prediction framework.

Therefore, the virtual metrology system of the present disclosure develops the automatic virtual metrology based on the long sequence time-series prediction framework, which can provide accurate predictive future trends to increase decision-making accuracy. The built-in period calculator is used to automatically find out the best memorizing length, the best forecasting length and the best full-periodic pattern length for the long sequence time-series prediction framework. The procedure of the advanced dual-phase algorithm is also enhanced to achieve self-updating with time for the automatic virtual metrology based on the long sequence time-series prediction framework.

In some embodiments, the manufacturing device includes a production equipment, a factory equipment and a microgrid equipment. The measurement device includes a power meter. The sets of process data include production line information of the production equipment, factory information of the factory equipment, microgrid information of the microgrid equipment and environmental information. Each of the phase-one virtual metrology value generated in the first step and the phase-two virtual metrology value generated in the second step is configured to control the manufacturing device, thereby updating the actual measurement values of the power meter.

In some embodiments, the period calculation operation further includes performing a first period calculating step, a second period calculating step, a third period calculating step, a fourth period calculating step and a fifth period calculating step. The first period calculating step includes defining a searching range, and the searching range is a positive integer greater than 1. The second period calculating step includes setting a lag value to 1. The third period calculating step includes calculating the sets of process data and the metrology data according to the autocorrelation function and the confidence interval function of the autocorrelation function to generate an autocorrelation function value and a confidence interval. The fourth period calculating step includes adding the lag value by 1 to generate an added lag value, and then setting the lag value to the added lag value. The fifth period calculating step includes judging whether the lag value exceeds the searching range to generate a judgment result, and then determining the full-periodic pattern length according to the judgment result.

In some embodiments, the period calculation operation further includes performing a sixth period calculating step, a seventh period calculating step and an eighth period calculating step. The sixth period calculating step includes finding the lag value when the autocorrelation function value falls into the confidence interval at a first time, and setting the memorizing length to the lag value when the autocorrelation function value falls into the confidence interval at the first time, and finding the lag value of a largest one of the autocorrelation function value that exceeds the memorizing length, and setting the full-periodic pattern length to the lag value of the largest one of the autocorrelation function value. The seventh period calculating step includes setting the forecasting length according to the memorizing length. The eighth period calculating step includes outputting the memorizing length, the forecasting length and the full-periodic pattern length. The forecasting length is a multiple of the memorizing length. In response to determining that the judgment result of the fifth period calculating step is yes, the sixth period calculating step is performed, and in response to determining that the judgment result of the fifth period calculating step is no, the third period calculating step is reperformed.

In some embodiments, in the calculating operation, in response to determining that the another actual measurement value is not obtained, performing the first step to calculate the phase-one virtual metrology value of the manufacturing device. In response to determining that the another actual measurement value is obtained, performing the second step to calculate the phase-two virtual metrology value of the manufacturing device.

In some embodiments, the first step includes converting another set of process data of the manufacturing device into a set of format length process data according to the memorizing length and the forecasting length, and then inputting the set of format length process data of the manufacturing device into the virtual metrology model based on the long sequence time-series prediction framework, thereby calculating the phase-one virtual metrology value of the manufacturing device.

In some embodiments, the second step includes performing a strategy selection confirming step on the another actual measurement value of the manufacturing device to generate a confirmation result, and performing one of a first strategy step and a second strategy step according to the confirmation result to update the virtual metrology model based on the long sequence time-series prediction framework; and inputting the another set of process data of the manufacturing device into the virtual metrology model based on the long virtual metrology value of the manufacturing device.

In some embodiments, the strategy selection confirming step includes confirming whether the manufacturing device performs a manual activation operation. In response to determining that the confirmation result is no, the second step further includes confirming whether the virtual metrology model based on the long sequence time-series prediction framework needs to be refreshed to generate a refreshing confirmation result, and determining whether to perform the first strategy step according to the refreshing confirmation result. In response to determining that the confirmation result is yes, the second step performs the second strategy step. The manual activation operation includes that the manufacturing device is expected to change significantly.

In some embodiments, in the second step, the first strategy step includes updating the virtual metrology model based on the long sequence time-series prediction framework according to the memorizing length and the forecasting length; and the second strategy step includes reperforming the period calculation operation to find another memorizing length, another forecasting length and another full-periodic pattern length, and then updating the virtual metrology model based on the long sequence time-series prediction framework according to the another memorizing length, the another forecasting length and the another full-periodic pattern length.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a virtual metrology system based on a long sequence time-series prediction framework according to a first embodiment of the present disclosure.

FIG. 2 shows a flow chart of a virtual metrology method based on a long sequence time-series prediction framework according to a second embodiment of the present disclosure.

FIG. 3 shows a schematic view of a deep learning based network of a long sequence time-series prediction framework and input-output correlation of the present disclosure.

FIG. 4 shows a flow chart of a period calculating operation of the present disclosure.

FIG. 5A shows a schematic view of an automatic searching result of the period calculating operation of the present disclosure.

FIG. 5B shows an enlarged schematic view of a part of the automatic searching result of FIG. 5A.

FIG. 5C shows an enlarged schematic view of another part of the automatic searching result of FIG. 5A.

FIG. 6 shows a schematic view of an energy consumption prediction result based on the long sequence time-series prediction framework of the present disclosure.

FIG. 7 shows a flow chart of an advanced dual-phase algorithm of a calculating operation of FIG. 2.

FIG. 8 shows a schematic view of an energy consumption prediction result based on the advanced dual-phase algorithm of FIG. 7.

### DETAILED DESCRIPTION

The embodiment will be described with the drawings. For clarity, some practical details will be described below. However, it should be noted that the present disclosure should not be limited by the practical details, that is, in some embodiment, the practical details are unnecessary. In addition, for simplifying the drawings, some conventional structures and elements will be simply illustrated, and repeated elements may be represented by the same labels.

It will be understood that when an element (or device, module) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

In the technical field of production automation, right decisions can only be made via understanding future trends. For example, energy consumption prediction is the basis of all energy management systems (EMS). Any EMS decision-making must rely on the energy consumption prediction value for subsequent power grid planning or factory management. These prediction values play decisive roles in planning and management. The present disclosure develops an automatic virtual metrology (AVM) based on a long sequence time-series prediction framework, which can provide accurate predictive future trends to increase decision-making accuracy (such as production scheduling or facility control). The built-in period calculator (PC) is used to automatically find out the best memorizing length (P), the best forecasting length (F) and the best full-periodic pattern length (T) for the long sequence time-series prediction framework. The procedure of an advanced dual-phase algorithm is also enhanced to achieve self-updating with time for the AVM based on the long sequence time-series prediction framework.

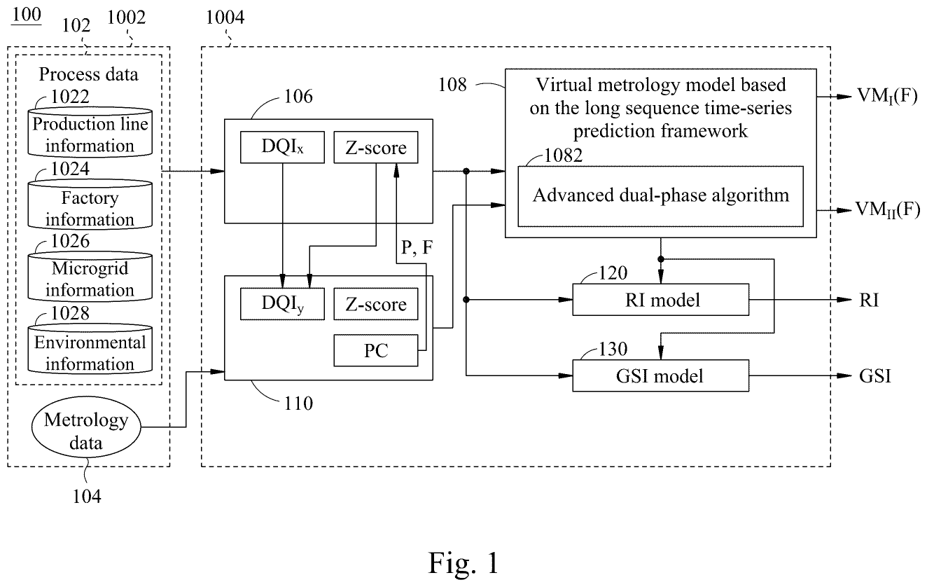

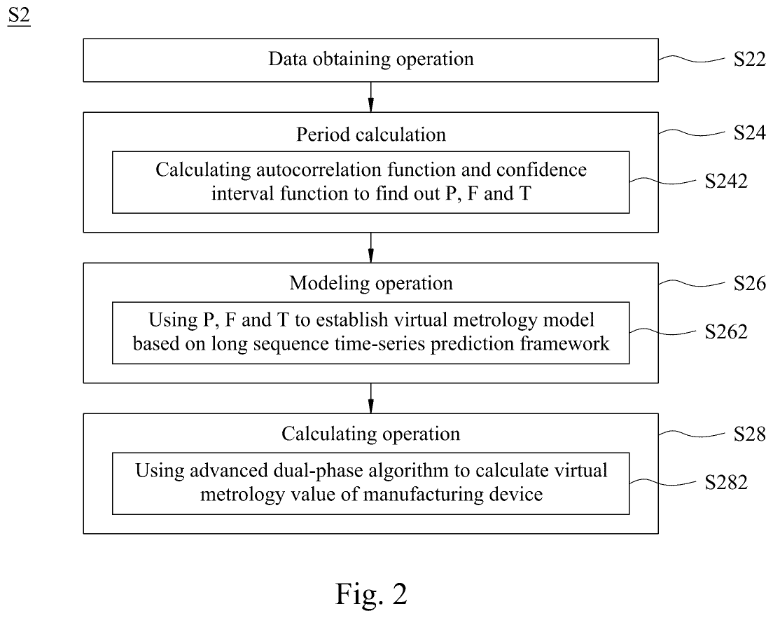

Referring to FIGS. 1 and 2. FIG. 1 shows a schematic view of a virtual metrology system 100 based on a long sequence time-series prediction framework according to a first embodiment of the present disclosure. FIG. 2 shows a flow chart of a virtual metrology method S2 based on a long sequence time-series prediction framework according to a second embodiment of the present disclosure. The virtual metrology system 100 based on the long sequence time-series prediction framework includes a memory 1002 and a processor 1004. The memory 1002 is configured to store a plurality of sets of process data 102 and a plurality of metrology data 104. The sets of process data 102 include past data and future data of a manufacturing device relative to a time point, and the metrology data 104 include a plurality of actual measurement values of a measurement device. Specifically, the sets of process data 102 include production line information 1022 of a production equipment, factory information 1024 of a factory equipment, microgrid information 1026 of a microgrid equipment and environmental information 1028. The manufacturing device includes the production equipment, the factory equipment and the microgrid equipment. The measurement device includes a power meter (e.g., a production power meter connected to the production equipment, a facility power meter connected to the factory equipment or a microgrid power meter connected to the microgrid equipment). In other words, the production line information 1022 comes from the production equipment of the manufacturing device. The factory information 1024 comes from the factory equipment of the manufacturing device, and the microgrid information 1026 comes from the microgrid equipment of the manufacturing device. The environmental information 1028 includes indoor environmental factor information, carbon inventory boundary information, gas inventory information and outdoor environmental factor information. In addition, the sets of process data 102 may further include a carbon emission, a low-carbon product process, enterprise organization information and carbon neutrality information. The carbon emission, the low-carbon product process and the carbon neutrality information comes from an intelligent carbon emission management system (iCMS). The enterprise organization information includes manufacturing execution system (MES) information, enterprise resource planning (ERP) information and factory basic demand information, but the present disclosure is not limited thereto.

The processor 1004 is electrically connected to the memory 1002. The processor 1004 receives the sets of process data 102 and the actual measurement values, and is configured to perform the virtual metrology method S2 based on the long sequence time-series prediction framework. In one embodiment, the processor 1004 includes the intelligent services of Industry 4.1, so that the original various types of prediction results can be obtained before the process of Industry 4.2 is achieved; the intelligent services of Industry 4.1 include automatic virtual metrology (AVM), intelligent predictive maintenance (IPM), intelligent yield management (IYM) and intelligent dispatching system (IDS). In addition, the processor 1004 further includes green intelligent manufacturing (GiM), intelligent carbon management and intelligent energy management.

The memory 1002 may include random access memory (RAM) or other types of dynamic storage devices that can store information and instructions for the processor 1004 to perform. The information and instructions include greenhouse gas emission factors, activity data, product carbon emission, streaming information management, blockchain and file system. The memory 1002 can be regarded as a database. The processor 1004 may include any type of processors (e.g., a cloud processor), microprocessors, or field programmable gate arrays (FPGA) capable of compiling and performing instructions. The processor 1004 may include a single device (e.g., single-core processor) or a group of devices (e.g., multiple-core processor), but the present disclosure is not limited thereto.

In order to automatically evaluate the quality of the data and the reliance of the evaluation results, the virtual metrology system 100 based on the long sequence time-series prediction framework includes a virtual metrology model 108 based on the long sequence time-series prediction framework and following functional modules: (1) a process data preprocessing module 106, which is configured to real-time evaluate the quality of the sets of process data 102 (based on a process data quality index (DQIₓ) model) and standardize the sets of process data 102, and preprocess the format of the sets of process data 102 by the memorizing length P, the forecasting length F generated from a period calculator PC of a metrology data preprocessing module 110. After preprocessing, only normal process data 102 can be used in the evaluation model for real-time quality evaluation. (2) a metrology data preprocessing module 110, which is configured to real-time evaluate the quality of the metrology data 104 (based on a metrology data quality index (DQI_{y}) model) and standardize the metrology data 104, and preprocess the format of the metrology data 104 by the memorizing length P, the forecasting length F generated from the period calculator PC. Only normal metrology data 104 after preprocessing can be used to fine-tune or retrain the evaluation model to increase accuracy of the evaluation model. (3) a reliance index (RI) model 120, which is configured to evaluate the reliance of the evaluation results. (4) a global similarity index (GSI) model 130, which is configured to evaluate global similarity between a current set of process data 102 and the historical process data 102 used for modeling, and assist the reliance indicator to more accurately evaluate the evaluation results. The abovementioned RI model 120, the GSI model 130, the DQIₓ model and the DQI_{y} model may refer to U.S. Pat. No. 8,095,484 B2. U.S. Pat. No. 8,095,484 B2 is hereby incorporated by reference.

In FIG. 2, the virtual metrology method S2 based on the long sequence time-series prediction framework is suitable for the virtual metrology system 100 based on the long sequence time-series prediction framework, and includes a plurality of steps S22, S24, S26, S28.

The step S22 is “Data obtaining operation”, and includes configuring the processor 1004 to obtain a plurality of sets of process data 102 and a plurality of metrology data 104. The sets of process data 102 include past data and future data of a manufacturing device relative to a time point. The metrology data 104 include a plurality of actual measurement values of a measurement device.

The step S24 is “Period calculation”, and includes performing a period calculation operation S242. The period calculation operation S242 includes configuring the processor 1004 to calculate the sets of process data 102 and the metrology data 104 according to an autocorrelation function (ACF) and a confidence interval (CI) function of the autocorrelation function so as to find out a memorizing length P, a forecasting length F and a full-periodic pattern length T for a long sequence time-series prediction framework.

The step S26 is “Modeling operation”, and includes performing a modeling operation S262. The modeling operation S262 includes configuring the processor 1004 to use the memorizing length P, the forecasting length F and the full-periodic pattern length T to establish a virtual metrology model 108 based on the long sequence time-series prediction framework. The virtual metrology model 108 based on the long sequence time-series prediction framework includes at least one deep learning network model.

The step S28 is “Calculating operation”, and includes performing a calculating operation S282. The calculating operation S282 includes configuring the processor 1004 to obtain at least one of another set of process data 102 and another actual measurement value of the manufacturing device, and executing one of a first step (Phase I) and a second step (Phase II) according to whether the another actual measurement value is obtained, thereby calculating one of a phase-one virtual metrology value VM_{I} (i.e., VM_{I} (F)) and a phase-two virtual metrology value VM_{II} (i.e., VM_{I} (F)) of the manufacturing device. The first step (Phase I) includes calculating the phase-one virtual metrology value VM_{I} by the another set of process data 102 according to the virtual metrology model 108 based on the long sequence time-series prediction framework, and the second step (Phase II) includes calculating the phase-two virtual metrology value VM_{II} of the manufacturing device by the another set of process data 102 and the another actual measurement value according to the virtual metrology model 108 based on the long sequence time-series prediction framework.

Specifically, the phase-one virtual metrology value VM_{I} can be one of the production-equipment predicted energy consumption information, the factory-equipment predicted energy consumption information, the renewable-energy-generator predicted power generation information, the estimated energy consumption of the optimal production schedule and the estimated energy consumption of the optimal facility control. The production-equipment predicted energy consumption information is corresponding to the production equipment. The factory-equipment predicted energy consumption information is corresponding to the factory equipment. The renewable-energy-generator predicted power generation information is corresponding to the microgrid equipment. The estimated energy consumption of the optimal production schedule is corresponding to the production equipment. The estimated energy consumption of the optimal facility control is corresponding to the factory equipment. In addition, each of the phase-one virtual metrology value VM_{I} generated in the first step and the phase-two virtual metrology value VM_{II} generated in the second step is configured to control the manufacturing device, thereby updating the actual measurement values of the power meter.

The virtual metrology method S2 based on the long sequence time-series prediction framework (an automatic virtual metrology algorithm) and the virtual metrology system 100 based on the long sequence time-series prediction framework (an automatic virtual metrology system) of the present disclosure are equipped with the capabilities of automatic data acquisition, automatic data quality evaluation, automatic model fanning out and automatic model refreshing, thus being capable of significantly saving time for manual data quality evaluation and modeling and suitable for whole-factory construction and deployment of virtual metrology.

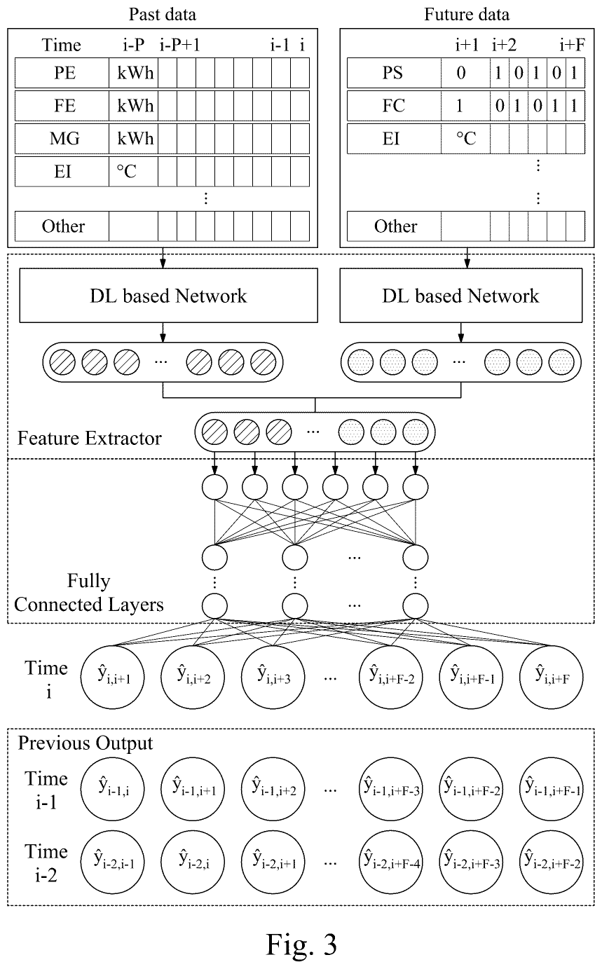

Referring to FIGS. 1, 2 and 3. FIG. 3 shows a schematic view of a deep learning based network of a long sequence time-series prediction framework and input-output correlation of the present disclosure. The data sources of the virtual metrology method S2 based on the long sequence time-series prediction framework and the virtual metrology system 100 based on the long sequence time-series prediction framework of the present disclosure are data of factory, environment, company decision-making (Tₖ₊₁ period) and equipment power meters (Tₖ period). For example, in energy prediction, it is necessary to collect the entire historical data (Tₖ₊₁ period) of the power meters, each equipment information (e.g., energy consumption (kWh) of an ice water machine, a chilled water flow rate (L/sec), a cooling water temperature (° C.), inlet and outlet water pressures (In) and refrigeration tonnage (RT) in an ice water system), environmental information (e.g., an outdoor temperature (° C.), a dew point temperature (° C.), humidity (%) and a wind speed (Mph)) and company decision-making (e.g., a production work order). Through the virtual metrology method S2 based on the long sequence time-series prediction framework, a changing type at the previous time point can be memorized in the virtual metrology model 108 based on the long sequence time-series prediction framework, and a changing trend at the next time point can be predicted based on the previous internal state and input. For example, high temperatures in summer and low temperatures in winter can be memorized, and the changing trend of temperature and possible abnormalities at the next time point can be predicted by learning the changing types of the temperatures, such as snowstorms or high temperature warnings.

The virtual metrology model 108 based on the long sequence time-series prediction framework of the present disclosure is an enhanced model. The virtual metrology model 108 based on the long sequence time-series prediction framework not only considers historical information, but also considers future information (such as temperature and humidity predicted by the meteorological bureau, scheduling results, etc.) used as features of the input model for accuracy of future prediction. The advantage of the long sequence time-series prediction framework which is divided into two different input sources (the past data and the future data) is that the model can perform different feature extractions on different input data, and after merging the extraction results from both feature extractions, the predicted value is finally outputted for a certain period of time in the future. The number of sample points referenced in the past is defined as the memorizing length P. The memorizing length P is used as a reference for information in the past time, including the energy consumption values collected by the power meter in the past time and indoor and outdoor temperature and humidity. The number of sample points referenced in the future is defined as the forecasting length F. The forecasting length F is used as a reference for information in the future time, including scheduling results, control results and temperature and humidity predicted by the meteorological bureau, as shown in FIG. 3. The two variables of the memorizing length P and the full-periodic pattern length T are automatically searched by the period calculator PC in the virtual metrology system 100 based on the long sequence time-series prediction framework. The memorizing length P and the forecasting length F not only greatly affect accuracy of the model, but also are the basis for data processing. The data preprocessing module will compile the data into a form usable by the virtual metrology model 108 based on the long sequence time-series prediction framework according to the two variables of the memorizing length P and the forecasting length F for model training and prediction. The past data include data of production equipment (PE), factory equipment (FE), microgrid (MG) and environmental information (EI). The future data include production scheduling (PS), facility control (FC) and environmental information (EI).

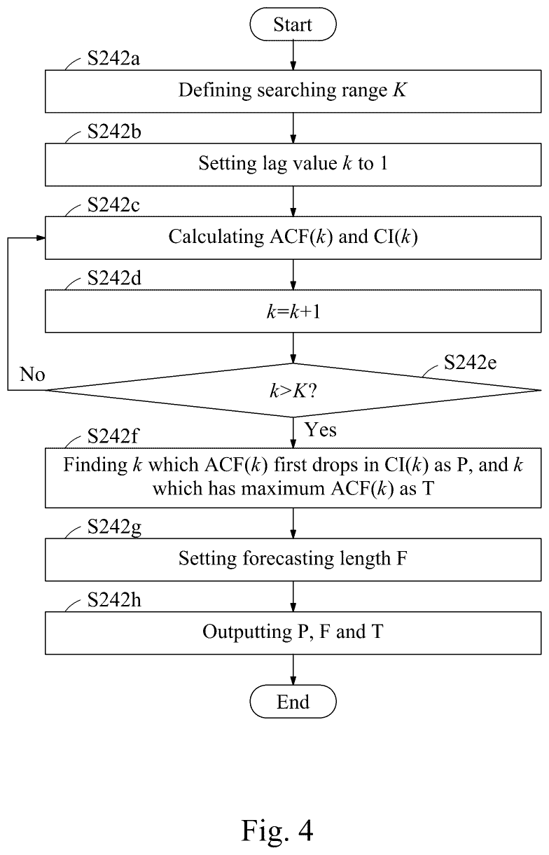

Referring to FIGS. 1, 2, 3 and 4. FIG. 4 shows a flow chart of a period calculating operation S242 of the present disclosure. The period calculation operation S242 further includes performing a first period calculating step S242a, a second period calculating step S242b, a third period calculating step S242c, a fourth period calculating step S242d, a fifth period calculating step S242e, a sixth period calculating step S242f, a seventh period calculating step S242g and an eighth period calculating step S242h.

The first period calculating step S242a includes defining a searching range K, and the searching range K is a positive integer greater than 1. The second period calculating step S242b includes setting a lag value k to 1. The third period calculating step S242c includes calculating the sets of process data 102 and the metrology data 104 according to the autocorrelation function and the confidence interval function of the autocorrelation function to generate an autocorrelation function value ACF(k) and a confidence interval CI(k). The fourth period calculating step S242d includes adding the lag value k by 1 to generate an added lag value (k+1), and then setting the lag value k to the added lag value (k+1). The fifth period calculating step S242e includes judging whether the lag value k exceeds the searching range K to generate a judgment result, and then determining the full-periodic pattern length T according to the judgment result. The sixth period calculating step S242f is “Finding k which ACF(k) first drops in CI(k) as P, and k which has maximum ACF(k) as T”, and includes finding the lag value k when the autocorrelation function value ACF(k) falls into the confidence interval CI(k) at the first time, and setting the memorizing length P to the lag value k when the autocorrelation function value ACF(k) falls into the confidence interval CI(k) at the first time, and finding the lag value k of a largest one of the autocorrelation function value ACF(k) that exceeds the memorizing length P, and setting the full-periodic pattern length T to the lag value k of the largest one of the autocorrelation function value ACF(k). The seventh period calculating step S242g includes setting the forecasting length F according to the memorizing length P, and the forecasting length F is a multiple of the memorizing length P. The eighth period calculating step S242h includes outputting the memorizing length P, the forecasting length F and the full-periodic pattern length T. When the judgment result of the fifth period calculating step S242e is yes, the sixth period calculating step S242f is performed; when the judgment result of the fifth period calculating step S242e is no, the third period calculating step S242c is reperformed.

The memorizing length P and the forecasting length F will affect accuracy of the prediction model. The full-periodic pattern length T is the basis for updating model. The memorizing length P and the full-periodic pattern length T can be automatically searched by the period calculator PC in the virtual metrology system 100 based on the long sequence time-series prediction framework. The forecasting length F can be set by a user. In one embodiment, a multiple of the memorizing length P is used as the forecasting length F, but the present disclosure is not limited thereto. The period calculator PC performs automatically searching by using the autocorrelation function and the confidence interval function of the autocorrelation function. The autocorrelation function is a statistical tool used in time series analysis to measure an autocorrelation between different time points in a time series. In other words, the autocorrelation function is used to assess the correlation between a variable and itself at different time points.

The autocorrelation function and the confidence interval function of the autocorrelation function conforms to the following formula:

$$ACF ( k ) = \frac{{\sum }_{i = 1}^{N - k} ( D ( i ) - \overline{D} ) ( D ( i + k ) - \overline{D} )}{{\sum }_{i = 1}^{N} {( D ( i ) - \overline{D} )}^{2}} ; \qquad ( 1 )$$

$$CI ( k ) = \pm {z}_{1 - α / 2} \sqrt{\frac{1}{N} ( 1 + 2 {\sum }_{i = 1}^{k} {ACF ( k )}^{2} )} ; \qquad ( 2 )$$

where D(i) represents time series data without lag; D(i+k) represents the time series data with lag k; D̅ represents average time series data; Z represents a Z-score value (standardized value); α represents a confidence level index; N represents a length of the time series data; and k represents the lag value.

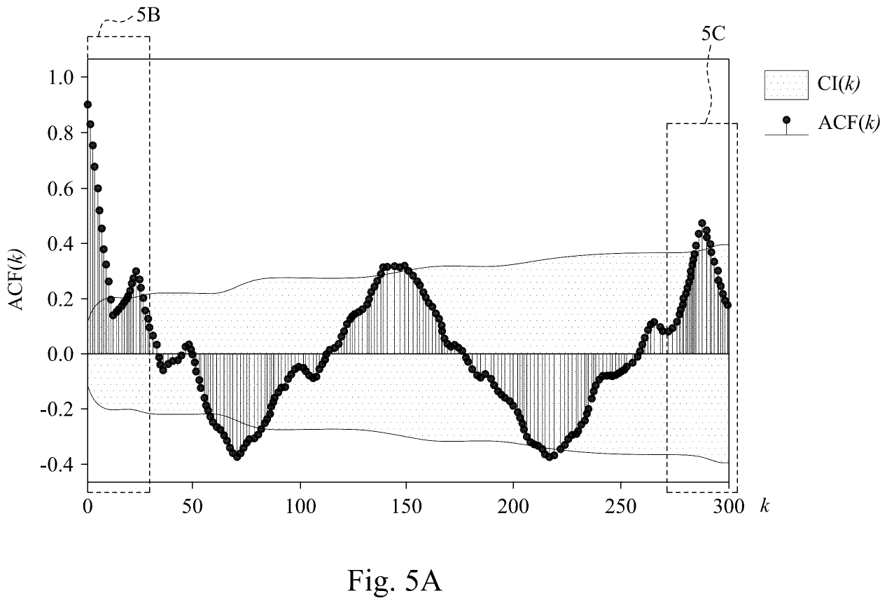

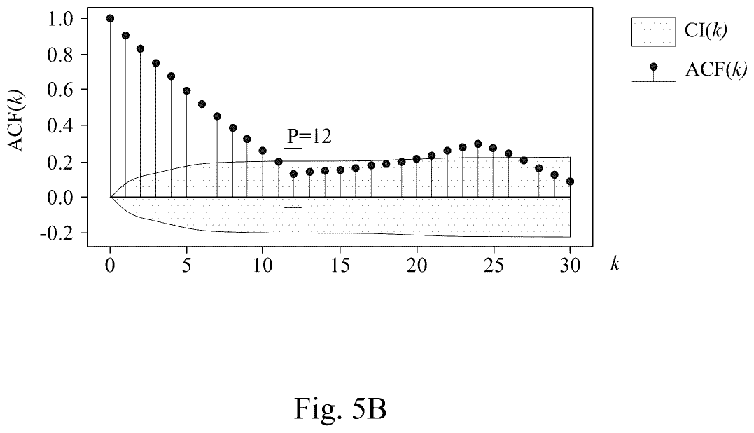

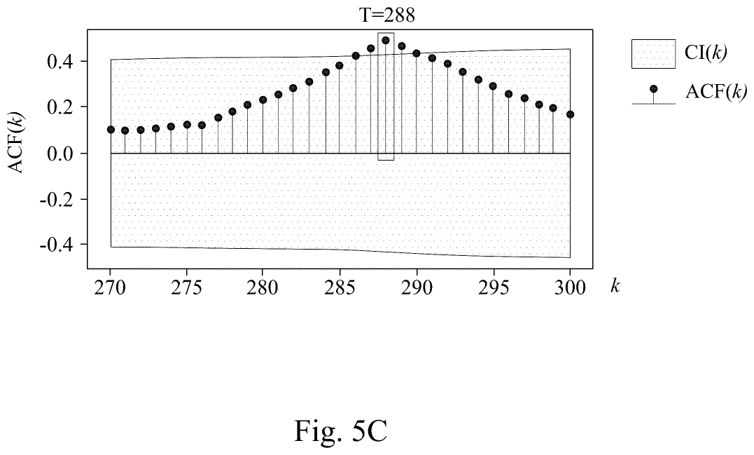

Referring to FIGS. 4, 5A, 5B and 5C. FIG. 5A shows a schematic view of an automatic searching result of the period calculating operation S242 of the present disclosure. FIG. 5B shows an enlarged schematic view of a part of the automatic searching result of FIG. 5A. FIG. 5C shows an enlarged schematic view of another part of the automatic searching result of FIG. 5A. In the embodiment, the memorizing length P and the full-periodic pattern length T are automatically searched when the searching range K=300, the confidence level index α=0.95, and the length of the time series data N=300. It is obvious that the lag value k is 12 when the autocorrelation function value ACF(k) falls into the confidence interval CI(k) at the first time, so that memorizing length P is set to 12. The lag value k of the largest one of the autocorrelation function value ACF(k) that exceeds the memorizing length P is 288, so that the full-periodic pattern length T is set to 288.

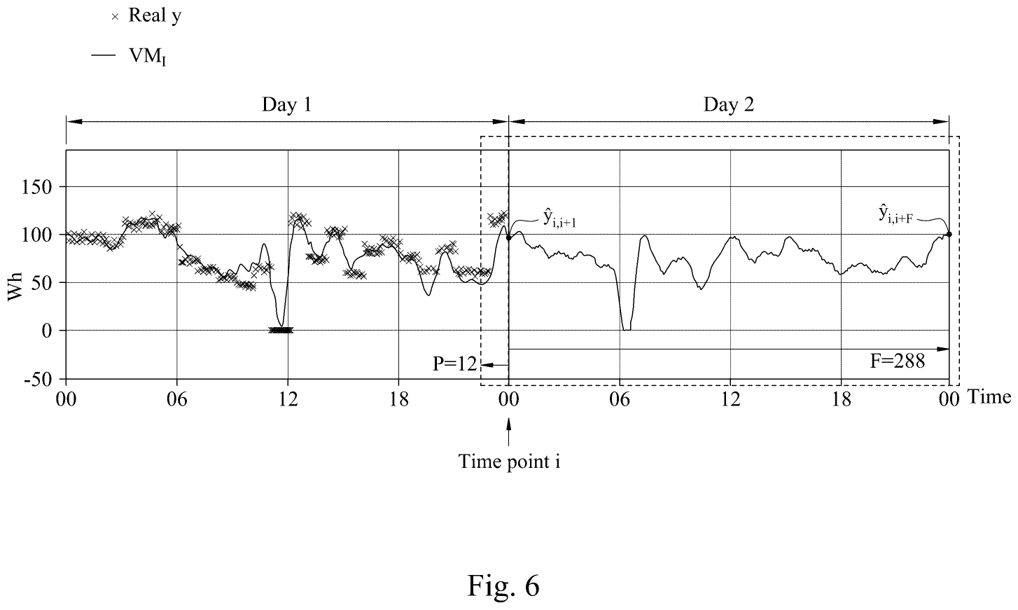

Referring to FIGS. 1, 2, 3, 4, 5A, 5B, 5C and 6. FIG. 6 shows a schematic view of an energy consumption prediction result based on the long sequence time-series prediction framework of the present disclosure. In the embodiment, the energy consumption prediction is performed in one day before time point i (Day 1) and one day after time point i (Day 2). The solid curve represents a model prediction result (i.e., the phase-one virtual metrology value VM_{I}), and the symbol “×” represents actual values (i.e., Real y). The model refers to the past data of past points (P=12, i.e., the number of the past points is 12) as the input of the model at time point i, and outputs predicted values (ŷ_{i,i+1}, ŷ_{i,i+2}, · · · , ŷ_{i,i+F}, F=288, i.e., the number of the predicted values is 288) at time point i. ŷ_{i,i+1} is the predicted value of time point i+1 relative to time point i, and ŷ_{i,i+F} is the predicted value of time point i+F relative to time point i. In order to measure the model performance, the present disclosure uses mean average percentage error (MAPE) as a measurement index. The MAPE conforms to the following formula:

$$MAPE = \frac{{\sum }_{i = 1}^{N} \vert \frac{{\hat{y}}_{i , j} - {y}_{j}}{max ( {y}_{train} )} \vert * 100 \%}{N} ; \qquad ( 3 )$$

where ŷ_{i,j} represents the predicted value of time point j calculated based on time point i, and j=i+1; yⱼ represents the actual value of time point j; yₜᵣₐᵢₙ represents the set of the actual values of training samples; N represents the total number of samples in calculation of MAPE. In FIG. 6, it is obvious that the predicted values are very close to the actual values, thus indicating that the prediction performance is good, and the MAPE is 4.402%.

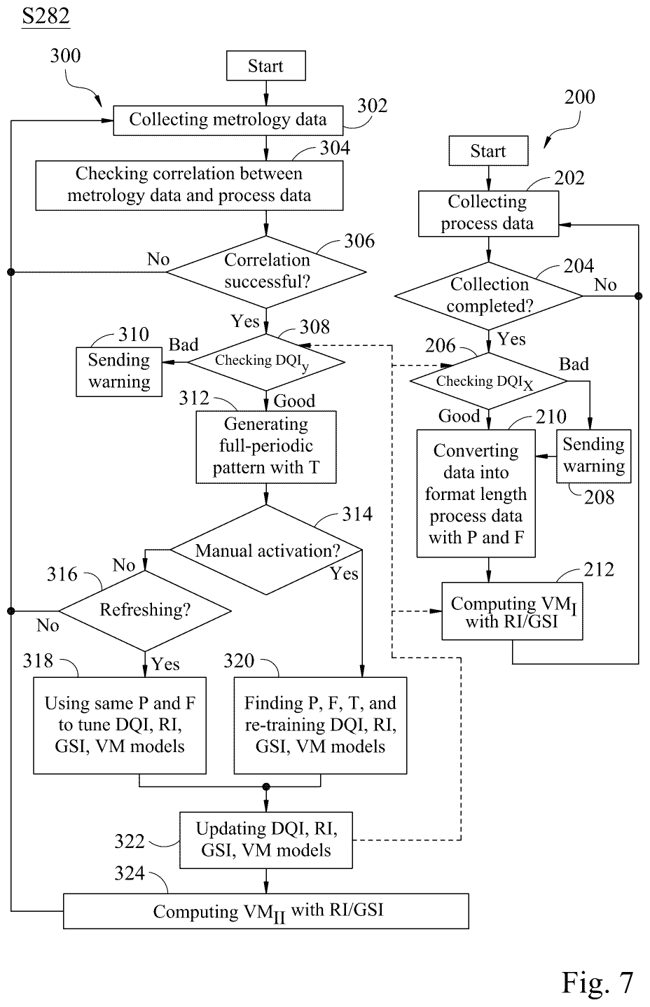

Referring to FIGS. 1, 2 and 7. FIG. 7 shows a flow chart of an advanced dual-phase algorithm 1082 of a calculating operation S282 of FIG. 2. In the calculating operation S282, in response to determining that the another actual measurement value is not obtained, performing a first step 200 to calculate the phase-one virtual metrology value VM_{I} of the manufacturing device. In contrast, in response to determining that the another actual measurement value is obtained, performing the second step 300 to calculate the phase-two virtual metrology value VM_{II} of the manufacturing device.

The first step 200 mainly focuses on real-time application. When new data is collected, a process data quality index (DQIx) checking algorithm is performed to confirm the data quality. If the data quality is bad, a warning is sent immediately. When the data quality checking is completed, the phase-one virtual metrology value VM_{I} and its corresponding reliance index RI and global similarity index GSI are output immediately.

In the first step 200, first, a step 202 is performed to collect the process data 102 of a process device. Next, a step 204 is performed to check whether the collection of the process data 102 of the process device is completed. If the result of the step 204 is no, the step 202 is performed continually. If the result of the step 204 is yes, a step 206 is performed to check the DQIx of the process data 102. If the result of the step 206 is bad, it represents that the process data 102 is abnormal data, and a warning is sent (a step 208). If the result of the step 206 is good, it represents that the process data 102 is normal data, and a step 210 is performed. The step 210 includes converting another set of process data 102 of the manufacturing device into a set of format length process data according to the memorizing length P and the forecasting length F. Finally, a step 212 is performed and includes inputting the set of format length process data of the manufacturing device into the virtual metrology model 108 based on the long sequence time-series prediction framework, thereby calculating the phase-one virtual metrology value VM_{I} of the manufacturing device.

The main task of the second step 300 is to obtain a parameter from the period calculating operation S242. The parameter, i.e., the full-periodic pattern length T, is very important for model updating. The full-periodic pattern length T can be automatically searched to be obtained by the period calculator PC. When new paired data are collected, a metrology data quality index (DQI_{y}) checking algorithm is performed to confirm the data quality. When the DQI_{y} checking algorithm confirms that the metrology data 104 is bad, a warning is sent. After confirming the data quality of the metrology data 104, three steps will be taken to improve the accuracy. The first of the three steps is to generate a full-periodic pattern, i.e., integrate the data into the full-periodic pattern based on full-periodic pattern length T as the basis for subsequent judgment of model updating. The second of the three steps is to perform manual activation, i.e., when future trends are expected to change significantly (e.g., seasonal changes, substantial changes in schedules or replacement of old and new factory equipment), the model can be forced to perform re-training. The period calculator PC is reused to find the memorizing length P, the forecasting length F and the full-periodic pattern length T, and re-train the DQI model, the RI model 120, the GSI model 130 and a VM model with the newly found memorizing length P, the newly found forecasting length F and newly found the full-periodic pattern length T (the VM model in this embodiment is the virtual metrology model 108 based on the long sequence time-series prediction framework). The third of the three steps is to perform refreshing, i.e., judging whether the model needs to be refreshed (tuning), e.g., the MAPE does not meet an accuracy threshold. If so, the same memorizing length P and the same forecasting length F are used to tune the DQI model, the RI model 120, the GSI model 130 and the VM model.

In the second step 300, first, a step 302 is performed to collect the actual metrology data 104 of the power meter. Next, a step 304 is performed to perform correlation check between the metrology data 104 and each of the production line information 1022, the factory information 1024, the microgrid information 1026, the environmental information 1028, i.e., check the correlation between the metrology data 104 and the process data 102. Then, a step 306 is performed to judge whether the correlation check is successful. If the result of the step 306 is no, the step 302 is performed continually. If the result of the step 306 is yes, a step 308 is performed to check the DQI_{y} to judge whether the actual metrology data 104 is normal, i.e., quality control DQI_{y} is performed on the metrology data 104. If the result of the step 308 is bad, a warning is sent (a step 310). If the result of the step 308 is good, a step 312 is performed to integrate the data into the full-periodic pattern based on full-periodic pattern length T.

Next, a step 314 is performed to confirm whether there is a need for manual activation of the model (e.g., seasonal changes, substantial changes in schedules or replacement of old and new factory equipment). If the result of the step 314 is yes, a step 320 is performed. If the result of the step 314 is no, a step 316 is performed. In other words, the second step 300 includes performing a strategy selection confirming step (i.e., the step 314) on the another actual measurement value of the manufacturing device to generate a confirmation result, and performing one of a first strategy step (i.e., a step 318) and a second strategy step (i.e., the step 320) according to the confirmation result to update the virtual metrology model 108 based on the long sequence time-series prediction framework; and inputting the another set of process data 102 of the manufacturing device into the virtual metrology model 108 based on the long sequence time-series prediction framework, thereby calculating the phase-two virtual metrology value VM_{II} of the manufacturing device. The strategy selection confirming step includes confirming whether the manufacturing device performs a manual activation operation. The manual activation operation includes that the manufacturing device is expected to change significantly. In response to determining that the confirmation result is yes, the second step 300 performs the second strategy step (i.e., the step 320). In response to determining that the confirmation result is no, the second step 300 further includes performing the step 316. The step 316 includes judging whether the model needs to be tuned or refreshed (e.g., the MAPE does not meet an accuracy threshold), i.e., confirming whether the virtual metrology model 108 based on the long sequence time-series prediction framework needs to be refreshed to generate a refreshing confirmation result, and determining whether to perform the first strategy step (i.e., the step 318) according to the refreshing confirmation result. If the refreshing confirmation result of the step 316 is yes, the step 318 is performed. If the refreshing confirmation result of the step 316 is no, the step 302 is performed continually.

The step 318 includes tuning the DQI model, the RI model 120, the GSI model 130 and the VM model by using the same memorizing length P and the same forecasting length F, i.e., updating the virtual metrology model 108 based on the long sequence time-series prediction framework according to the memorizing length P and the forecasting length F. The step 320 includes using the period calculator PC to find the memorizing length P, the forecasting length F and the full-periodic pattern length T, and re-train the DQI model, the RI model 120, the GSI model 130 and the VM model, that is, reperforming the period calculation operation S242 to find another memorizing length P, another forecasting length F and another full-periodic pattern length T, and then updating the virtual metrology model 108 based on the long sequence time-series prediction framework according to the another memorizing length P, the another forecasting length F and the another full-periodic pattern length T. Next, a step 322 is performed to update the DQI model, the RI model 120, the GSI model 130 and the VM model. Finally, a step 324 is performed to re-output the phase-two virtual metrology value VM_{I} whose length is the forecasting length F and its corresponding RI and GSI, and the step 302 is performed continually.

Therefore, the virtual metrology method S2 based on the long sequence time-series prediction framework and the virtual metrology system 100 based on the long sequence time-series prediction framework of the present disclosure develop the automatic virtual metrology (AVM) based on the long sequence time-series prediction framework, which can provide accurate predictive future trends to increase decision-making accuracy (such as production scheduling or facility control). The built-in period calculator PC is used to automatically find out the best memorizing length P, the best forecasting length F and the best full-periodic pattern length T for the long sequence time-series prediction framework. The procedure of the advanced dual-phase algorithm 1082 is also enhanced to achieve self-updating with time for the AVM based on the long sequence time-series prediction framework.

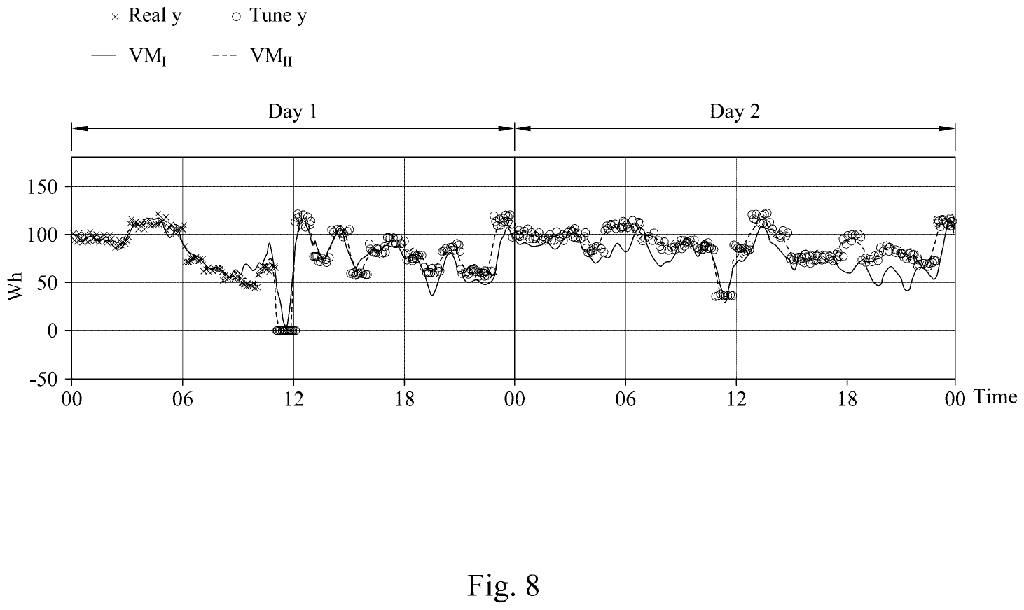

Referring to FIGS. 7 and 8. FIG. 8 shows a schematic view of an energy consumption prediction result based on the advanced dual-phase algorithm 1082 of FIG. 7. In the embodiment, the energy consumption prediction is performed in one day before a current time point (Day 1) and one day after the current time point (Day 2). The solid curve represents a first model prediction result (i.e., the phase-one virtual metrology value VM_{I}), and the dotted curve represents a second model prediction result (i.e., the phase-two virtual metrology value VM_{II}). The symbol “×” represents actual values (i.e., Real y), and the symbol “∘” represents updated actual values (i.e., Tune y). It can be seen from FIG. 8 that there is a big difference between the solid curve and the actual values in the one day after the current time point (Day 2), thus resulting in the MAPE as high as 9.757%. However, the present disclosure can update the models (based on the advanced dual-phase algorithm 1082). The updated dotted curve (i.e., the phase-two virtual metrology value VM_{II}) is closer to the updated actual values (i.e., Tune y), and the MAPE is also significantly improved to 4.114%.

It can be understood that the virtual metrology method S2 based on the long sequence time-series prediction framework of the present disclosure is the above-mentioned implementation steps, and the computer program product of the present disclosure is used to perform the virtual metrology method S2 based on the long sequence time-series prediction framework. The order of each implementation step described in the above embodiments can be adjusted, combined or omitted as needed. The aforementioned embodiments can be provided as a computer program product, which may include a machine-readable medium on which instructions are stored for programming a computer (or other electronic devices) to perform a process based on the embodiments of the present disclosure. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present disclosure also can be downloaded as a computer program product, which may be transferred from a remote computer to a requesting computer by using data signals via a communication link (such as a network connection or the like).

It is also noted that the present disclosure also can be described in the context of a manufacturing system. The present disclosure may be implemented in various manufacturing industries. The manufacturing system is configured to fabricate workpieces or products including, but not limited to, panel devices, semiconductor devices, LED devices, solar devices, microprocessors, memory devices, digital signal processors, application specific integrated circuits (ASICs), or other similar devices. The present disclosure may also be applied to other workpieces or manufactured products, such as vehicle wheels, screws and papermaking. The manufacturing system includes one or more processing tools that may be used to form one or more products, or portions thereof, in or on the workpieces (such as wafers, glass substrates and paper). Persons of ordinary skill in the art should appreciate that the processing tools may be implemented in any number of entities of any type, including lithography tools, deposition tools, etching tools, polishing tools, annealing tools, machine tools, and the like. In the embodiments, the manufacturing system also includes one or more metrology tools, such as scatterometers, ellipsometers, scanning electron microscopes, and the like.

According to the aforementioned embodiments and examples, the advantages of the present disclosure are described as follows.

1. The virtual metrology method and the virtual metrology system of the present disclosure develop the AVM based on the long sequence time-series prediction framework, and can automatically find out the best memorizing length, the best forecasting length and the best full-periodic pattern length for the long sequence time-series prediction framework by the deep learning model and the built-in period calculator, thus providing accurate predictive future trends to increase decision-making accuracy.

2. The virtual metrology method and the virtual metrology system of the present disclosure provide a model updating method (the advanced dual-phase algorithm) suitable for the long sequence time-series prediction framework to be capable of increasing adaptability and feasibility of the AVM on various applications and achieve self-updating with time for the AVM, thereby solving the problem that the conventional AVM cannot predict future trends.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A virtual metrology method based on a long sequence time-series prediction framework, comprising:
configuring a processor to obtain a plurality of sets of process data and a plurality of metrology data, wherein the sets of process data comprise past data and future data of a manufacturing device relative to a time point, and the metrology data comprise a plurality of actual measurement values of a measurement device;
performing a period calculation operation, wherein the period calculation operation comprises:
configuring the processor to calculate the sets of process data and the metrology data according to an autocorrelation function and a confidence interval function of the autocorrelation function so as to find out a memorizing length, a forecasting length and a full-periodic pattern length for the long sequence time-series prediction framework;
performing a modeling operation, wherein the modeling operation comprises:
configuring the processor to use the memorizing length, the forecasting length and the full-periodic pattern length to establish a virtual metrology model based on the long sequence time-series prediction framework, wherein the virtual metrology model based on the long sequence time-series prediction framework comprises at least one deep learning network model; and
performing a calculating operation, wherein the calculating operation comprises:
configuring the processor to obtain at least one of another set of process data and another actual measurement value of the manufacturing device, and executing one of a first step and a second step according to whether the another actual measurement value is obtained, thereby calculating one of a phase-one virtual metrology value and a phase-two virtual metrology value of the manufacturing device;
wherein the first step comprises calculating the phase-one virtual metrology value by the another set of process data according to the virtual metrology model based on the long sequence time-series prediction framework, and the second step comprises calculating the phase-two virtual metrology value of the manufacturing device by the another set of process data and the another actual measurement value according to the virtual metrology model based on the long sequence time-series prediction framework.

2. The virtual metrology method based on the long sequence time-series prediction framework of claim 1, wherein the manufacturing device comprises a production equipment, a factory equipment and a microgrid equipment, the measurement device comprises a power meter, the sets of process data comprise production line information of the production equipment, factory information of the factory equipment, microgrid information of the microgrid equipment and environmental information, and each of the phase-one virtual metrology value generated in the first step and the phase-two virtual metrology value generated in the second step is configured to control the manufacturing device, thereby updating the actual measurement values of the power meter.

3. The virtual metrology method based on the long sequence time-series prediction framework of claim 1, wherein the period calculation operation further comprises:
performing a first period calculating step, wherein the first period calculating step comprises defining a searching range, and the searching range is a positive integer greater than 1;
performing a second period calculating step, wherein the second period calculating step comprises setting a lag value to 1;
performing a third period calculating step, wherein the third period calculating step comprises calculating the sets of process data and the metrology data according to the autocorrelation function and the confidence interval function of the autocorrelation function to generate an autocorrelation function value and a confidence interval;
performing a fourth period calculating step, wherein the fourth period calculating step comprises adding the lag value by 1 to generate an added lag value, and then setting the lag value to the added lag value; and
performing a fifth period calculating step, wherein the fifth period calculating step comprises judging whether the lag value exceeds the searching range to generate a judgment result, and then determining the full-periodic pattern length according to the judgment result.

4. The virtual metrology method based on the long sequence time-series prediction framework of claim 3, wherein the period calculation operation further comprises:
performing a sixth period calculating step, wherein the sixth period calculating step comprises finding the lag value when the autocorrelation function value falls into the confidence interval at a first time, and setting the memorizing length to the lag value when the autocorrelation function value falls into the confidence interval at the first time, and finding the lag value of a largest one of the autocorrelation function value that exceeds the memorizing length, and setting the full-periodic pattern length to the lag value of the largest one of the autocorrelation function value;
performing a seventh period calculating step, wherein the seventh period calculating step comprises setting the forecasting length according to the memorizing length; and
performing an eighth period calculating step, wherein the eighth period calculating step comprises outputting the memorizing length, the forecasting length and the full-periodic pattern length;
wherein the forecasting length is a multiple of the memorizing length, in response to determining that the judgment result of the fifth period calculating step is yes, the sixth period calculating step is performed, and in response to determining that the judgment result of the fifth period calculating step is no, the third period calculating step is reperformed.

5. The virtual metrology method based on the long sequence time-series prediction framework of claim 1, wherein in the calculating operation,
in response to determining that the another actual measurement value is not obtained, performing the first step to calculate the phase-one virtual metrology value of the manufacturing device; and
in response to determining that the another actual measurement value is obtained, performing the second step to calculate the phase-two virtual metrology value of the manufacturing device.

6. The virtual metrology method based on the long sequence time-series prediction framework of claim 5, wherein the first step comprises:
converting another set of process data of the manufacturing device into a set of format length process data according to the memorizing length and the forecasting length, and then inputting the set of format length process data of the manufacturing device into the virtual metrology model based on the long sequence time-series prediction framework, thereby calculating the phase-one virtual metrology value of the manufacturing device.

7. The virtual metrology method based on the long sequence time-series prediction framework of claim 5, wherein the second step comprises:
performing a strategy selection confirming step on the another actual measurement value of the manufacturing device to generate a confirmation result, and performing one of a first strategy step and a second strategy step according to the confirmation result to update the virtual metrology model based on the long sequence time-series prediction framework; and
inputting the another set of process data of the manufacturing device into the virtual metrology model based on the long sequence time-series prediction framework, thereby calculating the phase-two virtual metrology value of the manufacturing device.

8. The virtual metrology method based on the long sequence time-series prediction framework of claim 7, wherein the strategy selection confirming step comprises:
confirming whether the manufacturing device performs a manual activation operation;
wherein in response to determining that the confirmation result is no, the second step further comprises:
confirming whether the virtual metrology model based on the long sequence time-series prediction framework needs to be refreshed to generate a refreshing confirmation result, and determining whether to perform the first strategy step according to the refreshing confirmation result;
wherein in response to determining that the confirmation result is yes, the second step performs the second strategy step;
wherein the manual activation operation comprises that the manufacturing device is expected to change significantly.

9. The virtual metrology method based on the long sequence time-series prediction framework of claim 8, wherein in the second step,
the first strategy step comprises updating the virtual metrology model based on the long sequence time-series prediction framework according to the memorizing length and the forecasting length; and
the second strategy step comprises reperforming the period calculation operation to find another memorizing length, another forecasting length and another full-periodic pattern length, and then updating the virtual metrology model based on the long sequence time-series prediction framework according to the another memorizing length, the another forecasting length and the another full-periodic pattern length.

10. A virtual metrology system based on a long sequence time-series prediction framework, comprising:
a memory configured to store a plurality of sets of process data and a plurality of metrology data, wherein the sets of process data comprise past data and future data of a manufacturing device relative to a time point, and the metrology data comprise a plurality of actual measurement values of a measurement device; and
a processor electrically connected to the memory, wherein the processor receives the sets of process data and the actual measurement values, and is configured to:
perform a period calculation operation, wherein the period calculation operation comprises:
calculating the sets of process data and the metrology data according to an autocorrelation function and a confidence interval function of the autocorrelation function so as to find out a memorizing length, a forecasting length and a full-periodic pattern length for the long sequence time-series prediction framework;
perform a modeling operation, wherein the modeling operation comprises:
using the memorizing length, the forecasting length and the full-periodic pattern length to establish a virtual metrology model based on the long sequence time-series prediction framework, wherein the virtual metrology model based on the long sequence time-series prediction framework comprises at least one deep learning network model; and
performing a calculating operation, wherein the calculating operation comprises:
obtaining at least one of another set of process data and another actual measurement value of the manufacturing device, and executing one of a first step and a second step according to whether the another actual measurement value is obtained, thereby calculating one of a phase-one virtual metrology value and a phase-two virtual metrology value of the manufacturing device;
wherein the first step comprises calculating the phase-one virtual metrology value by the another set of process data according to the virtual metrology model based on the long sequence time-series prediction framework, and the second step comprises calculating the phase-two virtual metrology value of the manufacturing device by the another set of process data and the another actual measurement value according to the virtual metrology model based on the long sequence time-series prediction framework.

11. The virtual metrology system based on the long sequence time-series prediction framework of claim 10, wherein the manufacturing device comprises a production equipment, a factory equipment and a microgrid equipment, the measurement device comprises a power meter, the sets of process data comprise production line information of the production equipment, factory information of the factory equipment, microgrid information of the microgrid equipment and environmental information, and each of the phase-one virtual metrology value generated in the first step and the phase-two virtual metrology value generated in the second step is configured to control the manufacturing device, thereby updating the actual measurement values of the power meter.

12. The virtual metrology system based on the long sequence time-series prediction framework of claim 10, wherein the period calculation operation further comprises:
performing a first period calculating step, wherein the first period calculating step comprises defining a searching range, and the searching range is a positive integer greater than 1;
performing a second period calculating step, wherein the second period calculating step comprises setting a lag value to 1;
performing a third period calculating step, wherein the third period calculating step comprises calculating the sets of process data and the metrology data according to the autocorrelation function and the confidence interval function of the autocorrelation function to generate an autocorrelation function value and a confidence interval;
performing a fourth period calculating step, wherein the fourth period calculating step comprises adding the lag value by 1 to generate an added lag value, and then setting the lag value to the added lag value; and
performing a fifth period calculating step, wherein the fifth period calculating step comprises judging whether the lag value exceeds the searching range to generate a judgment result, and then determining the full-periodic pattern length according to the judgment result.

13. The virtual metrology system based on the long sequence time-series prediction framework of claim 12, wherein the period calculation operation further comprises:
performing a sixth period calculating step, wherein the sixth period calculating step comprises finding the lag value when the autocorrelation function value falls into the confidence interval at a first time, and setting the memorizing length to the lag value when the autocorrelation function value falls into the confidence interval at the first time, and finding the lag value of a largest one of the autocorrelation function value that exceeds the memorizing length, and setting the full-periodic pattern length to the lag value of the largest one of the autocorrelation function value;
performing a seventh period calculating step, wherein the seventh period calculating step comprises setting the forecasting length according to the memorizing length; and
performing an eighth period calculating step, wherein the eighth period calculating step comprises outputting the memorizing length, the forecasting length and the full-periodic pattern length;
wherein the forecasting length is a multiple of the memorizing length, in response to determining that the judgment result of the fifth period calculating step is yes, the sixth period calculating step is performed, and in response to determining that the judgment result of the fifth period calculating step is no, the third period calculating step is reperformed.

14. The virtual metrology system based on the long sequence time-series prediction framework of claim 10, wherein in the calculating operation,
in response to determining that the another actual measurement value is not obtained, performing the first step to calculate the phase-one virtual metrology value of the manufacturing device; and
in response to determining that the another actual measurement value is obtained, performing the second step to calculate the phase-two virtual metrology value of the manufacturing device.

15. The virtual metrology system based on the long sequence time-series prediction framework of claim 14, wherein the first step comprises:
converting another set of process data of the manufacturing device into a set of format length process data according to the memorizing length and the forecasting length, and then inputting the set of format length process data of the manufacturing device into the virtual metrology model based on the long sequence time-series prediction framework, thereby calculating the phase-one virtual metrology value of the manufacturing device.

16. The virtual metrology system based on the long sequence time-series prediction framework of claim 14, wherein the second step comprises:
performing a strategy selection confirming step on the another actual measurement value of the manufacturing device to generate a confirmation result, and performing one of a first strategy step and a second strategy step according to the confirmation result to update the virtual metrology model based on the long sequence time-series prediction framework; and
inputting the another set of process data of the manufacturing device into the virtual metrology model based on the long sequence time-series prediction framework, thereby calculating the phase-two virtual metrology value of the manufacturing device.

17. The virtual metrology system based on the long sequence time-series prediction framework of claim 16, wherein the strategy selection confirming step comprises:
confirming whether the manufacturing device performs a manual activation operation;
wherein in response to determining that the confirmation result is no, the second step further comprises:
confirming whether the virtual metrology model based on the long sequence time-series prediction framework needs to be refreshed to generate a refreshing confirmation result, and determining whether to perform the first strategy step according to the refreshing confirmation result;
wherein in response to determining that the confirmation result is yes, the second step performs the second strategy step;
wherein the manual activation operation comprises that the manufacturing device is expected to change significantly.

18. The virtual metrology system based on the long sequence time-series prediction framework of claim 17, wherein in the second step,
the first strategy step comprises updating the virtual metrology model based on the long sequence time-series prediction framework according to the memorizing length and the forecasting length; and
the second strategy step comprises reperforming the period calculation operation to find another memorizing length, another forecasting length and another full-periodic pattern length, and then updating the virtual metrology model based on the long sequence time-series prediction framework according to the another memorizing length, the another forecasting length and the another full-periodic pattern length.
